(19) United States
(12) Patent Application Publication
(10) Pub. No.: US 2024/0335024 A1
(43) Pub. Date: Oct. 10, 2024

(54) Magnetic Stabilization System for Double Strap Bags

(71) Applicant: Guohao Lyu, Huizhou (CN)

(72) Inventor: Guohao Lyu, Huizhou (CN)

(21) Appl. No.: 18/130,976

(22) Filed: Apr. 5, 2023

(51) Int. Cl. A45F 3/04; A45F 3/12

(52) U.S. Cl. CPC A45F 3/04; A45F 3/12; A45F 2003/003; F41C 33/06; G10G 7/005

(57) ABSTRACT

The present invention relates to a magnetic stabilization system for double strap bags, such as backpacks, designed to efficiently and conveniently secure and stabilize bag straps when not in use. The inventive design features at least one strap with a magnet installed along its length and a corresponding magnet or ferromagnetic metal installed along the length of the other strap, enabling the straps to form a stable X shape when overlaid. The straps are uniquely angled and shaped with respect to their connection to the bag body, facilitating the formation of the X-shaped crossover. The magnetic stabilization system provides a more practical, user-friendly solution to prevent the straps from shaking, dragging, or becoming tangled, while maintaining a sleek and uncluttered appearance.

### FIELD OF INVENTION

The present invention relates generally to double strap bags, such as backpacks, and more particularly to a magnetic stabilization system for conveniently securing and stabilizing bag straps when not in use, preventing them from shaking or rubbing against the ground.

### BACKGROUND

Double strap bags, particularly backpacks, are widely used for carrying various items, including school supplies, laptops, and other personal belongings. A common issue with these bags is that users frequently carry the bags by alternative means, such as separate handles, or simply place the bags down when not in use. In such situations, the straps, which are typically designed to be long enough to wrap around the user's shoulders, are left loose and can shake, drag along the floor, or become tangled. This is not only inconvenient but can also lead to increased wear and tear on the straps.

Several prior art designs have attempted to address this problem by incorporating buckles at the end of the straps or providing special pockets for tucking the straps away when not in use. However, these solutions often require time-consuming and inconvenient manual operations, such as unbuckling and re-buckling the straps and stuffing them into the pockets. In everyday life, users typically find such operations too cumbersome, and as a result, they often neglect to secure the straps, allowing them to shake, drag, or become tangled.

There remains a need for an improved strap stabilization system that is more convenient, efficient, and practical for daily use, while maintaining a simple and aesthetically pleasing appearance.

It is within this context that the present invention is provided.

### SUMMARY

The present invention provides a novel double strap bag design featuring a magnetic stabilization system that efficiently and conveniently addresses the aforementioned problems associated with loose and unsecured bag straps. The system comprises at least one strap with a magnet installed along its length and a corresponding magnet or ferromagnetic metal installed along the length of the other strap, allowing the straps to form a stable X shape when overlaid.

The system may also incorporate a unique angle and shape of the straps in relation to their connection with the bag body, facilitating the formation of the X-shaped crossover. Unlike conventional bag designs, where the straps are nearly perpendicular to their connection with the bag body, the straps of the present invention form an oblique angle biased towards the center of the bag body, promoting an X-shaped arrangement. This angle typically ranges between 15 and 45 degrees. The objectives can be further facilitated by having the straps form a pair of mirrored curves curving inwards towards the bag's center.

In addition to providing a more convenient and efficient stabilization solution, the present invention also offers several secondary features.

For example, a printed product logo or graphic can be added to the strap's surface to indicate the magnet's position, making it easier for the user to locate and engage the magnetic stabilization system.

The magnets can also be used to attach various magnetic accessories and charms, enhancing the bag's aesthetic appeal and functionality.

Furthermore, the magnet's location is typically set in the middle of the strap's length, while the top portion of the strap near the bag body has minimal padding, allowing for easier deformation and engagement of the magnetic stabilization system.

Overall, the present invention offers a more practical and user-friendly approach to stabilizing bag straps, providing users with a simple yet effective solution that prevents the straps from shaking, dragging, or becoming tangled, while maintaining a sleek and uncluttered appearance.

### BRIEF DESCRIPTION OF THE DRAWINGS

Various embodiments of the invention are disclosed in the following detailed description and accompanying drawings.

FIG. 1 shows a person holding a double strap guitar bag with a standard strap configuration as is known in the art.

FIG. 2A shows a person holding a double strap guitar bag with a detachable strap configuration with pockets for stowing the strap as is known in the art.

FIGS. 2B and 2C show the loose straps of the stowable configuration being detached and stored in a special pocket.

FIG. 3 shows an isometric perspective view of a double strap guitar bag utilizing an example configuration of a magnetic stabilization system according to the present disclosure.

FIG. 4A shows a frontal view of the example configuration with the straps apart.

FIG. 4B shows a frontal view of the example configuration with the straps secured in an X-shape by the magnetic pairing mechanism.

FIG. 5A shows a pair of strap according to the present disclosure in a parted position with a mark indicating the position of the magnets inside the padding.

FIG. 5B shows the same pair of straps secured in the X-shape.

FIG. 6 shows a person holding the double strapped guitar bag with the magnetic stabilization system according to the present disclosure.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention. As used herein, the term “and/or” includes any combinations of one or more of the associated listed items.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terminology used herein is for the purpose of describing particular embodiments only and is not intended to be limiting. As used herein, the singular forms “a,” “an” and “the” are intended to include the plural forms as well, unless the context clearly indicates otherwise.

The terms “first,” “second,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

In accordance with the present disclosure, a magnetic stabilization system for double strap bags is provided, comprising at least one strap with a magnet installed along its length and a corresponding magnet or ferromagnetic metal installed along the length of the other strap. The unique angle and shape of the straps in relation to their connection with the bag body facilitate the formation of the X-shaped crossover, providing a more efficient and user-friendly solution to the loose strap problem. The invention further incorporates secondary features, such as a printed product logo or graphic indicating the magnet's position, and the ability to attach magnetic accessories and charms.

While the present invention has been illustrated with reference to guitar bags, it should be understood that the magnetic stabilization system can be applied to any kind of double strapped bag, including but not limited to standard rucksacks, backpacks, gun bags, and other carrying cases.

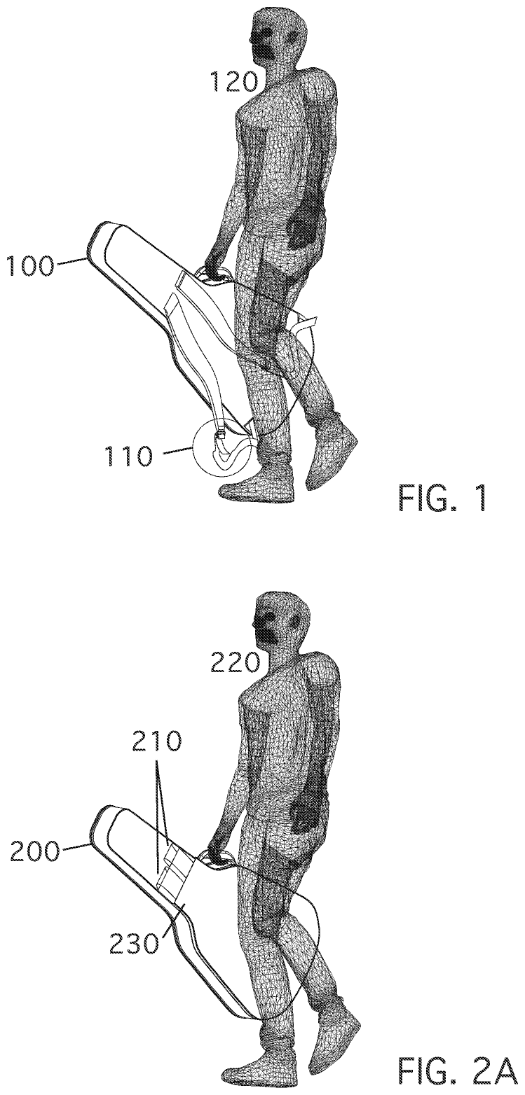

Referring now to the drawings, FIG. 1 illustrates a prior art configuration of a person 120 holding a double strap guitar bag 100 with standard bag straps 110. The straps 110 can be seen hanging loose and at risk of dragging along the floor, causing inconvenience and potential damage to the straps.

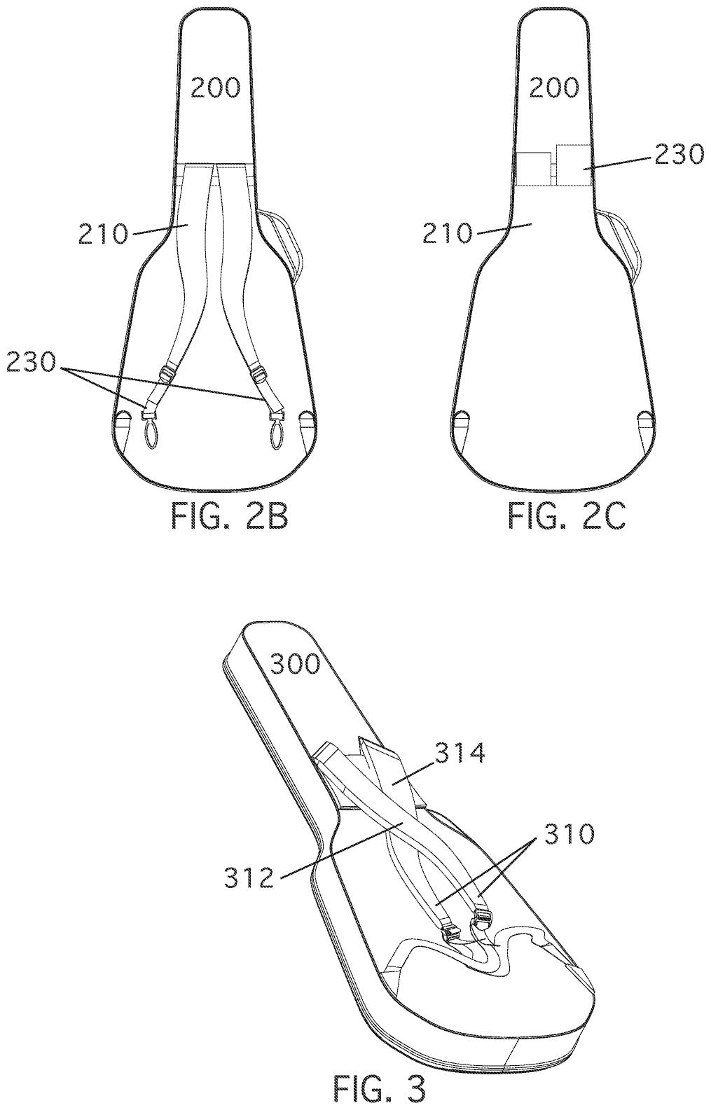

FIG. 2A shows another prior art configuration, where a person 220 holds a double strap guitar bag 200 with detachable straps 210 and pockets 220 for stowing the straps. FIGS. 2B and 2C further illustrate the drawbacks of the prior art, as the loose straps 210 are detached and stored in the special pocket 230. As can be seen, this process would be cumbersome to perform several times a day, highlighting the need for a more efficient and user-friendly solution.

In contrast, FIG. 3 onwards depict the present invention and its advantages over the prior art configurations.

FIG. 3 shows an isometric perspective view of a double strap guitar bag 300 utilizing an example configuration of the magnetic stabilization system according to the present disclosure. The straps 310 are crossed in the X-shape, held against one another by the magnetic stabilization system. The first strap 312 will have a magnet installed within the padding at a fixed point along its length where the two strap cross over, and the second strap 314 will have a magnet or ferromagnetic component installed along its length, positioned so as to correspond with the magnet of the first strap 312 when the first and second straps are overlaid in an X-shape.

The straps 310 may be constructed with padding and a durable fabric or material, such as nylon or polyester. Within the padding of at least one of the straps 310, a magnet is installed along its length. The other strap 310 features a corresponding magnet or ferromagnetic metal installed along its length. These magnets or ferromagnetic metals are positioned such that they align when the straps are overlaid in the X-shape, allowing the magnetic force to hold the straps securely in place.

The unique angle and shape of the straps 310 in relation to their connection with the bag body 320 facilitate the formation of the X-shaped crossover. Unlike conventional bag designs, where the straps are nearly perpendicular to their connection with the bag body, the straps of the present invention form an oblique angle biased towards the center of the bag body, promoting an X-shaped arrangement. This angle typically ranges between 15 and 45 degrees and can be further facilitated by having the straps form a pair of mirrored curves curving inwards towards the bag's center.

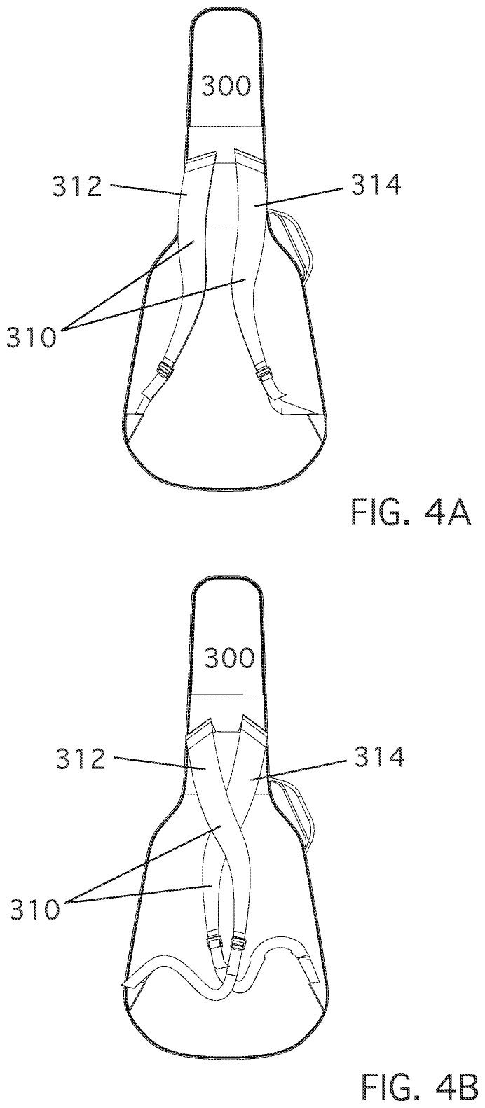

FIG. 4A shows a frontal view of the example configuration with the straps 310 apart. FIG. 4B shows a frontal view of the example configuration with the straps 310 secured in an X-shape by the magnetic pairing mechanism. The transition between FIG. 4A and FIG. 4B can be achieved quickly and easily, providing a more convenient solution than the detachable strap configuration illustrated in FIGS. 2A-2C.

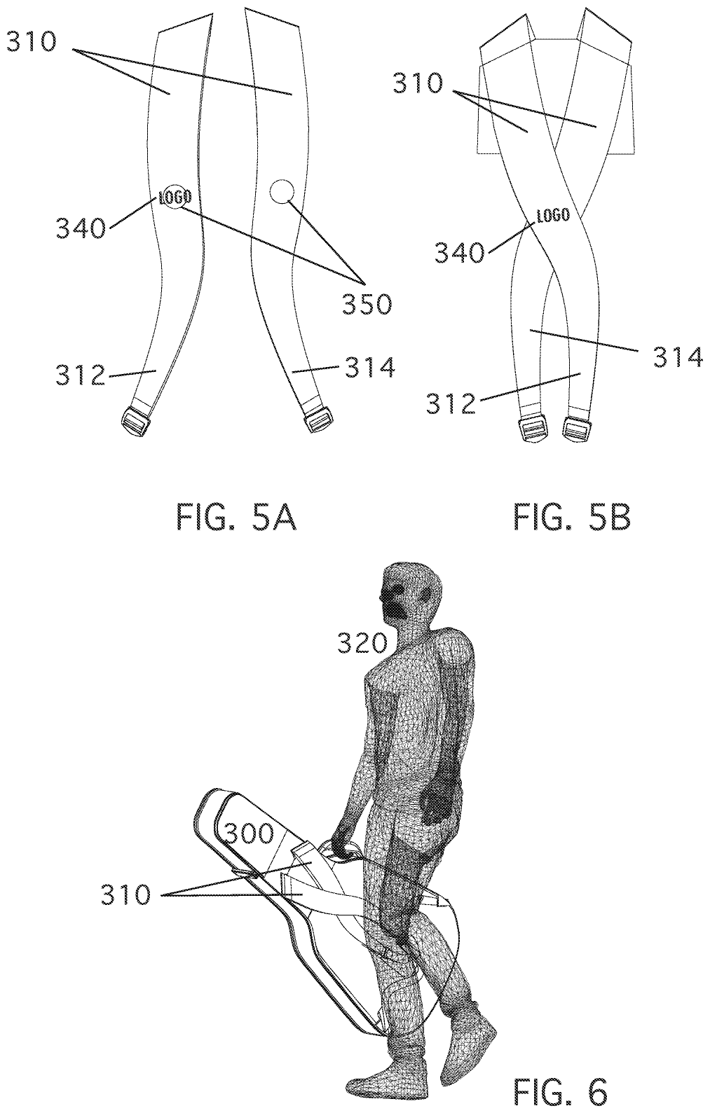

FIG. 5A shows the pair of straps 310 according to the present disclosure in a parted position with a mark 340 indicating the position of the magnets 350 inside the padding. The positions of the magnets 350 or ferromagnetic components are marked with dashed lines in the drawing. FIG. 5B shows the same pair of straps 310 secured in the X-shape by the magnetic stabilization system.

A printed product logo or graphic could be added to the strap's surface, indicating the magnet's position and making it easier for the user to locate and engage the magnetic stabilization system. The magnets can also be used to attach various magnetic accessories and charms, enhancing the bag's aesthetic appeal and functionality.

FIG. 6 shows a person 320 holding a double strapped guitar bag 300 with the magnetic stabilization system according to the present disclosure. The straps 310 are secured in the X-shape by the magnetic pairing mechanism, providing a more efficient and user-friendly solution to the loose strap problem.

The magnetic stabilization system provides a practical, efficient, and aesthetically pleasing solution to the problems associated with loose and unsecured bag straps, making it suitable for a wide variety of applications.

Overall, the present invention offers significant advantages over the prior art, including increased convenience, simplicity, and versatility. By providing an efficient and user-friendly solution to the loose strap problem, the magnetic stabilization system enhances the user experience and usability of double strapped bags across various applications.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A magnetic stabilization system for double strap bags, comprising:
a bag body;
a first strap and a second strap, each strap having a first end and a second end, wherein the first end of each strap is attached to the bag body;
a magnet installed along the length of the first strap;
a magnet or ferromagnetic component installed along the length of the second strap, the magnet or ferromagnetic component of the second strap being positioned to correspond with the magnet of the first strap when the first and second straps are overlaid in an X-shape; and
wherein the first strap and the second strap form an oblique angle with the bag body at their connection points, the oblique angle being biased towards the center of the bag body and facilitating the formation of the X-shaped crossover.

2. The magnetic stabilization system of claim 1, wherein the first strap and the second strap each comprise padding, and the magnet and the ferromagnetic component are installed within the padding of the respective straps.

3. The magnetic stabilization system of claim 1, wherein the oblique angle between each strap and the bag body at the connection point is between 15 and 45 degrees.

4. The magnetic stabilization system of claim 1, wherein the first strap and the second strap each form a mirrored curve, curving inwards towards the center of the bag body, up to the point where the magnet and the ferromagnetic component are located along their length.

5. The magnetic stabilization system of claim 1, further comprising a printed product logo or graphic on the surface of at least one of the straps, indicating the position of the magnet within the strap padding.

6. The magnetic stabilization system of claim 1, further comprising at least one magnetic accessory or charm attachable to at least one of the straps by means of the magnet.

7. The magnetic stabilization system of claim 1, wherein the bag body is a guitar bag, rucksack, backpack, gun bag, or any other suitable carrying case with double straps.

8. The magnetic stabilization system of claim 1, wherein the first and second straps have a small portion near their connection points to the bag body with minimal padding to enable easier deformation and formation of the X-shape.
